(19) United States
(12) Patent Application Publication
(10) Pub. No.: US 2010/0262538 A1
(43) Pub. Date: Oct. 14, 2010

(54) METHODS AND SYSTEMS FOR CHECK OR ELECTRONIC BILL PAYMENT USING PORTIONAL CREDITING FROM ADDITIONAL AVAILABLE CASH AND CREDIT BALANCES

(76) Inventor: Ronald John Rosenberger, Newtown, PA (US)

Correspondence Address: Guy Kevin Townsend, 1079 S. VAN GORDON COURT, LAKEWOOD, CO, 80228, US

(21) Appl. No.: 12/665,033

(22) PCT Filed: Jun. 15, 2008
(86) PCT No.: PCT/US08/67056

§ 371 Date: Jun. 21, 2010

Related U.S. Application Data
(60) Provisional application No. 60/934,668, filed on Jun. 16, 2007.

(51) Int. Cl. G06Q 20/00; G06Q 40/00

(52) U.S. Cl. 705/40

(57) ABSTRACT

The present invention provides check (draft) payment or electronic bill payment using alternative debiting and accounting functions from associated cash or credit balances that allow flexibility and control by the payer or credit balance provider for enabling crediting of check or electronic bill payments to additional cash or credit balances that further provide opportunities for the account provider or financial institution to have additional income from providing such methods and systems.

### FIELD OF THE INVENTION

The present invention provides check (draft) payment or electronic bill payment using alternative debiting and accounting functions from associated cash or credit balances that allow flexibility and control by the payer or account issuer for enabling crediting of check or electronic bill payments to additional cash or credit balances that further provide opportunities for the account provider or financial institution to have additional income from providing such methods and systems.

### BACKGROUND OF THE RELATED ART

Known check payment functions include remote capture that allows electronic check submission without having to deliver the physical check draft to a bank, as well as numerous other innovations. Electronic bill payments enable a payer to debit funds from a demand deposit account (DDA account), or other cash balances, and pay a bill electronically to a payee without needing to use a check draft. As known in the prior art, a payer is a person or entity that sends or originates a check draft or electronic bill payment, or is a party responsible for paying a bill. A payee is a person or entity to whom a check is made out, or is the recipient of a payer's electronic bill payment. A payee may comprise an individual, merchant, product or service provider, and the like.

Generally, financial accounts comprise either cash based or credit based accounts. Cash accounts can include a demand deposit account (DDA), a negotiable order of withdrawal (NOW) account, a checking account, a savings account, a money market account, a stored value account, and the like. Credit accounts can include a charge account, a revolving credit account, a line of credit, a home equity line of credit account (HELOC), a credit card account, and the like.

With regards to the movement and reconcilement of funds pertaining to check and electronic bill payments, such is typically performed in the United States of America using the Automated Clearing House (ACH), with an analogous system in Europe being the Pan-European Automated Clearing House (PE-ACH).

### SUMMARY OF THE PRESENT INVENTION

In the present invention payer accounts, available account balances, etc., are intended as belonging to the payer. The terms “payer” and “customer” are herein interchangeable.

The term “available cash balance” can include any kind of available cash balance that can be used to facilitate check or electronic bill payments, such as but not limited to, a demand deposit account balance (DDA), a negotiable order of withdrawal (NOW) account balance, checking account balance, money market account balance, stored value account balance, and the like. The term “available credit balance” can include, but is not limited to, any kind of available credit balance that can be used to make check or electronic bill payments such as, but not limited to, a charge account balance, a revolving credit balance, a line of credit balance, home equity line of credit balance (HELOC), etc.

The present invention provides methods and systems for crediting of at least one portion of at least one check (draft) payment or electronic bill payment by debiting additional cash or credit balances using alternative debiting and accounting functions that allow flexibility and control by the payer or account issuer for enabling or facilitating check or electronic bill payments that further provide opportunities for the account provider or financial institution to have additional income by charging additional fees for providing such methods and systems.

The present invention provides a method, using a check or electronic bill payment account provided by an account provider for at least one payment of at least one check or electronic bill payment between a payer and payee, for providing at least one manual or automatic unpayment readjustment of said at least one payment, wherein (a) said unpayment readjustment comprises at least one transaction specific readjustment or at least one amount specific readjustment; (b) said unpayment readjustment does not affect said payee's receipt of said check or electronic bill payment; and (c) said at least one payment was paid by one selected from (i) debiting at least one available first cash balance or (ii) initially debiting at least one available first credit balance and then crediting said at least one first credit balance by debiting at least one available second cash balance; said method comprising: A. identifying at least one posted check or electronic bill payment transaction comprising said transaction specific readjustment, or specifying at least one amount comprising said amount specific readjustment; B. unpaying at least a portion of the amount of said at least one posted check or electronic bill payment transaction, or said amount comprising said amount specific readjustment, by debiting said portion of the amount of said posted check or electronic bill payment, or debiting said amount comprising said amount specific readjustment, among at least one of said at least one available first credit balance or at least one available second credit balance; and C. crediting said portion of the amount of said posted check or electronic bill payment pertaining to said unpayment, or crediting said amount comprising said amount specific readjustment pertaining to said unpayment, among at least one of said available first or second cash balance or second credit balance or at least one available third cash or credit balance.

Such methods also provide a method, using a check or electronic bill payment account provided by an account provider for payment of at least one check or electronic bill payment between a payer and payee, for providing at least one manual or automatic unpayment readjustment comprising at least one transaction specific readjustment or at least one amount specific readjustment, wherein said unpayment readjustment does not affect said payee's receipt of said check or electronic bill payment, comprising: (a) identifying at least one posted check or electronic bill payment transaction comprising said transaction specific readjustment, or specifying at least one amount comprising said amount specific readjustment, wherein available cash balance funds corresponding to said posted check or electronic bill payment transaction, or available cash balance funds corresponding to said amount comprising said amount specific readjustment, were frozen, and where said frozen funds are earmarked for the paid-together payment of said check or electronic bill payment; and (b) unfreezing at least a portion corresponding to the amount of said posted check or electronic bill payment transaction, or unfreezing said amount comprising said amount specific readjustment.

Such methods can include wherein said at least one portion is a percentage or amount of said at least one check or electronic bill payment amount, wherein said percentage is 0.001 to 100.000 percent or any value or range therein, and wherein said amount is $0.001 to at least $100,000 US dollars or any foreign equivalent thereof. Such methods can also include wherein said crediting or debiting is from a cash balance in a cash account or a credit balance in a credit account. Such methods can include wherein said cash account is a debit account or said credit account is a credit card account. Such methods can also include wherein said at least one of said available cash and credit balances is selected from in-house or out-of-house available credit or cash balances. Such methods can also include wherein said check or electronic payment account comprises a first available credit balance and a first available cash balance. Such a methods said unpayment readjustment is applied to said at least one check or electronic bill payment as a security feature that allows fraudulent check or electronic bill payments to be unpaid from said at least one cash balance with said at least one credit balance.

The present invention can also include a method for providing a check or electronic bill payment account by an account provider for at least one payment of at least one check or electronic bill payment between a payer and payee, comprising: (a) debiting at least one available first credit balance for said payment of said check or electronic bill payment, where said debiting comprises the posting and paying of said payment, and said payment comprises a debit; and, (b) crediting said at least one first credit balance by debiting at least one available second balance.

Such methods can include wherein said second balance is a cash or second credit balance. Such methods can also include wherein said debit is individually paid in-turn at a given time interval by said second balance. Such methods can further include wherein said debit comprises a plurality of debits that are automatically paid together at a given time interval by said second balance. Such methods can also include wherein said check or electronic payment account comprises a first available credit balance and a first available cash balance.

One or more given debiting of at least one portion of at least one posted check or electronic bill payment to additional cash or credit balances can include any combination or permutations of in-house, and/or out-of-house available credit and/or cash balances. Furthermore, a given electronic bill payment may comprise where 1) a payer initiates a electronic bill payment by sending, or “pushing” a payment to a payee from the payer's payment account; or, 2) where a payee initiates a electronic bill payment by “pulling” a payment from a payer's payment account. A given electronic bill payment, as discussed within this disclosure and/or illustrated in the following examples, can be considered as being a “pushed” or “pulled” electronic bill payment. Also, there are no limiting aspects with regards to the following examples, therefore a given example can be deemed to illustrate “pushed” and/or “pulled” electronic bill payments, in any combination. Also, there is nothing that limits whether a given embodiment is a check payment embodiment, an electronic bill payment embodiment, or both, resulting where any given embodiment can be used for checks and/or electronic bill payments.

The present invention also provides in one aspect methods and systems for providing checks or electronic bill payments from two or more associated balances that can be employed to enable checks that include both credit and debit aspects. These “crebit” methods and systems comprise where the check or electronic bill payment does not directly debit at least one available cash balance associated with the check or electronic bill payment account; rather, an available credit balance associated with the account is debited, whereby the debit to the credit balance that is created by the check or electronic bill payment is subsequently credited by a debit to said available cash balance(s).

Such “crebit” methods and systems can include where a given at least one portion of at least one posted check draft or electronic bill payment is debited from an initial available credit balance, and within any time interval, such as instantaneously or immediately upon or after the debit to the initial available credit balance occurs, or, two minutes, two hours, two days, etc., after the debit to the initial available credit balance occurs, said debit is credited automatically, or “paid in-turn”, by a debit to at least one available cash balance; or, a plurality of debits to the initial available credit balance are automatically “paid together” at once at any given time interval, such as before, at, or after the end of a billing cycle.

### DESCRIPTION OF THE INVENTION

The present invention provides methods and systems for the debiting of at least one available credit balance for at least one portion of at least one check (draft) payment or electronic bill payment, where said debiting is credited by debiting additional cash or credit balances using alternative debiting and accounting functions that allow flexibility and control by the payer or account issuer for enabling or facilitating check or electronic bill payments that further provide opportunities for the account provider or financial institution to have additional income by charging additional fees for providing such methods and systems.

The term “available cash balance” can include any kind of available cash balance that can be used to facilitate check or electronic bill payments, such as but not limited to, a demand deposit account balance (DDA), a negotiable order of withdrawal (NOW) account balance, checking account balance, money market account balance, stored value account balance, and the like. The term “available credit balance” can include but is not limited to, any kind of available credit balance that can be used to make check or electronic bill payments such as, but not limited to, a charge account balance, a revolving credit balance, a line of credit balance, home equity line of credit balance (HELOC), etc.

With regards to using one or more cash or credit available balances according to the present invention, at least one available balance can be maintained at the same financial institution as the check or electronic bill payment account, where such at least one available balance is in-house. Alternatively, at least one associated, linked or related available balance can be maintained at a different financial institution than the check or electronic bill payment account, where such at least one available balance is out-of-house. Where two or more available balances are used, such available balances can be in-house, out-of-house, or any combination thereof. While the check or electronic bill payment account would be typically linked with at least one out-of-house available balance in the United States of America using the Automated Clearing House (ACH), the present invention places no limitations whatsoever on the types of methods or systems that may be used to link the check or electronic bill payment account with at least one out-of-house available balance.

In one aspect, the present invention provides a method or system for crediting at least one portion of at least one check or electronic bill payment posted to at least one first available credit balance, comprising (a) debiting said at least one portion of said at least one posted check or electronic bill payment from at least one first available cash balance or at least one second available credit balance.

These and other aspects of the present invention are further described, but not limited by, the following examples, which are only illustrative of specific examples of the present invention.

### EXAMPLES

In the examples to follow, check or electronic bill payment is exemplified. While the following examples will attempt to be illustrative, they are non-limiting to the scope of the present invention.

This first example shows a common, everyday, check or electronic bill payment, whereby each check or electronic bill payment debits a payer's available cash balance:

| | | | Amt Debited |
|---|---|---|---|
| Date | Description | Amount | Frm Cash Bal |
| 01-02 | Check/Payment | 40.00 | 40.00 |
| 01-09 | Check/Payment | 20.00 | 20.00 |
| 01-15 | Check/Payment | 60.00 | 60.00 |
| 01-20 | Check/Payment | 40.00 | 40.00 |
| 01-23 | Check/Payment | 20.00 | 20.00 |
| 01-28 | Check/Payment | 80.00 | 80.00 |
| | TOTAL | 260.00 | 260.00 |

Less traditionally per current methods, user-adjustable check or electronic bill payment parameters can enable the automatic debiting of two or more available cash balance funding sources. In the following example using an amount threshold parameter, checks/payments up to $40 debit cash balance #1, whereby checks/payments above $40 debit cash balance #2.

| | | | Cash Bal | Cash Bal |
|---|---|---|---|---|
| Date | Description | Amount | #1 Debit | #2 Debit |
| 01-02 | Check/Payment | 40.00 | 40.00 | -0- |
| 01-09 | Check/Payment | 20.00 | 20.00 | -0- |
| 01-15 | Check/Payment | 60.00 | -0- | 60.00 |
| 01-20 | Check/Payment | 40.00 | 40.00 | -0- |
| 01-23 | Check/Payment | 20.00 | 20.00 | -0- |
| 01-28 | Check/Payment | 80.00 | -0- | 80.00 |
| | TOTAL | 260.00 | 120.00 | 140.00 |

In addition to the amount threshold parameter, other parameters include, e.g., remainder threshold (“debit the first $20 of the check/payment from available cash balance #1 and debit any remainder amount above $20 from available cash balance #2”); ratio (“debit 50% of the check/payment from available cash balance #1 and debit the remaining 50% from available cash balance #2”); account balance information (“debit checks/payments up to $20 from available cash balance #1 and debit checks/payments over $20 from available cash balance #2; however, if available cash balance #1 falls below $100, then only debit available account balance #2 for all checks/payments”) and, account balance consumption (“if consumption relating to check or electronic bill payments exceeds $100 for the day, then debit available cash balance #2, otherwise, debit available cash balance #1”, or, “if consumption relating to check or electronic bill payments exceeds $1000 for the month, then debit available cash balance #2, otherwise, debit available cash balance #1”).

Check or Electronic Bill Payments—“Paid in-Turn” Embodiments

This next example shows where check or electronic bill payments are made, but an initial credit balance is debited by the check or electronic bill payment amount, and within any time interval, such as instantaneously or immediately upon or after the debit to the initial available credit balance occurs, or, two minutes, two hours, two days, etc., after the debit to the initial available credit balance occurs, said debit is “paid in-turn” and credited automatically by a debit to the available cash balance, whereby the initial available credit balance is zeroed-out (paid in full).

| | | | Credit Bal | Amt Debited | Net Effect |
|---|---|---|---|---|---|
| Date | Description | Amount | Debit | Frm Cash Bal | Credit Bal |
| 01-02 | Check/Payment | 40.00 | 40.00 | 40.00 | -0- |
| 01-09 | Check/Payment | 20.00 | 20.00 | 20.00 | -0- |
| 01-15 | Check/Payment | 60.00 | 60.00 | 60.00 | -0- |
| 01-20 | Check/Payment | 40.00 | 40.00 | 40.00 | -0- |
| 01-23 | Check/Payment | 20.00 | 20.00 | 20.00 | -0- |
| 01-28 | Check/Payment | 80.00 | 80.00 | 80.00 | -0- |
| | TOTAL | 260.00 | 260.00 | 260.00 | -0- |

Here, the debit to the initial credit balance caused by a check or electronic bill payment is in many cases (with exceptions to be discussed) a temporary situation that exists only until the debit is automatically paid by at least one available cash balance. Being that there is no real “loan” in many cases due to the impending payment by at least one available cash balance, it is possible that certain, if not all, fees and interest normally associated with using a credit balance would be minimized or waived altogether, or never levied in the first place, with certain fees and/or interest being applicable to any credit balance items that remain open for any particular length of time, where said fees and/or interest are typical of credit balance usage in general.

In traditional check payment or electronic bill payment systems, a given check or bill payment coincidentally provides the payee with access information about the payer's available cash balance used to pay said payment. Such access information can ultimately jeopardize the payer's available cash balance by placing it directly in the “line of fire” for fraudulent abuse purposes. What is viewed as especially salient is that by first debiting a credit balance for a check payment or electronic bill payment, the credit balance acts as a “credit firewall” for any available cash balances associated with a given the check payment or electronic bill payment embodiments. In certain credit-based financial instruments, such as credit card accounts, account providers have federally mandated metrics that provide remedies such as limited liability for fraudulent activity. Such analogous metrics can be applied to check or bill payments that post to, or debit, an available credit balance instead of an available cash balance. Such comprises a feature that can offer an advantage for a given account provider, and can also result in avenues for fee revenue generation from customers that wish to avail themselves to such features.

The following example is a “paid in-turn” check or electronic bill payment embodiment using two available cash balances, although any number of cash balances (or even credit balances) may be used. Here, using an amount threshold parameter, checks/payments up to $40 debit cash balance #1, whereby checks/payments above $40 debit cash balance #2.

| | | | Credit Bal | Amt Debited | Amt Debited |
|---|---|---|---|---|---|
| Date | Description | Amount | Debit | Cash Bal #1 | Cash Bal #2 |
| 01-02 | Check/Payment | 40.00 | 40.00 | 40.00 | -0- |
| 01-09 | Check/Payment | 20.00 | 20.00 | 20.00 | -0- |
| 01-15 | Check/Payment | 60.00 | 60.00 | -0- | 60.00 |
| 01-20 | Check/Payment | 40.00 | 40.00 | 40.00 | -0- |
| 01-23 | Check/Payment | 20.00 | 20.00 | 20.00 | -0- |
| 01-28 | Check/Payment | 80.00 | 80.00 | -0- | 80.00 |
| | TOTAL | 260.00 | 260.00 | 120.00 | 140.00 |

As disclosed in the earlier check or electronic bill payment section regarding two or more available cash balance funding sources, in addition to the amount threshold parameter, other parameters adapted to check or electronic bill payments comprise: remainder threshold (“debit the first $20 of the check/payment amount from available cash balance #1, and debit any remainder amount above $20 from available cash balance #2”); ratio (“debit 1/3 (one third) of the check/payment amount from available cash balance #1, and debit 2/3 (two thirds) of the check/payment amount from available cash balance #2”); account balance information (“debit checks/payments up to $20 from available cash balance #1 and debit checks/payments over $20 from available cash balance #2; however, if available cash balance #1 falls below $100, then only debit available account balance #2 for all checks/payments”), and account balance consumption (“if consumption relating to check or electronic bill payments exceeds $100 for the day, then debit available cash balance #2, otherwise, debit available cash balance #1”, or (“if consumption relating to check or electronic bill payments exceeds $1000 for the month, then debit available cash balance #2, otherwise, debit available cash balance #1”).

An important point needs to be made here. As mentioned in the above example, and carrying through to the following examples as well, at least one available credit balance may be used as a funding source, in addition to, or in place of, at least one available cash balance. As mentioned earlier, an available credit balance may comprise any kind of available credit balance, comprising a charge account balance, a revolving credit balance, a line of credit balance, home equity line of credit balance (HELOC), etc.

Furthermore, with check or electronic bill payment parameters that enable a given check or electronic bill payment to draw from two or more funding sources simultaneously, said funding sources may comprise any combination or permutation of in-house or out-of-house available cash balances and/or in-house or out-of-house available credit balances. Finally, in such embodiments that employ more than one available credit balance, where said more than one available credit balances comprise either at least one initial available credit balance that is debited for the check or electronic bill payment amount, and/or at least one funding source available credit balance, it is disclosed that any or all available credit balances comprising a given embodiment may comprise identical or different billing cycles.

Two or more payment sources can “back up” each other; so, in the above example if cash balance #1 was depleted, then cash balance #2 can take over using “Best Fit” (debit at least one payment source that can “best fit”, or best accommodate, the check or electronic bill payment) and/or “Rescue or Reject” (either “rescue” the check or electronic bill payment by using at least one other non-depleted available balance as a partial/full payment source in place of, or in addition to, the balance(s) depleted before or during the check or electronic bill payment, or “reject” the check or electronic bill payment). As that any combination of in-house or out-of-house available cash and/or credit balances may be used as payment sources, the use of any combination of in-house or out-of-house available cash and/or credit balances applies with regards to “Best Fit” and/or “Rescue or Reject” criteria as well.

Check or Electronic Bill Payment—“Paid in-Turn”—Depleted Available Cash Balance

In the next example, check or electronic bill payments are allowed even when the available cash balance is depleted.

| | | | Credit Bal | Amt Debited | Net Debit |
|---|---|---|---|---|---|
| Date | Description | Amount | Debit | Frm Cash Bal | Credit Bal |
| 01-02 | Check/Payment | 40.00 | 40.00 | 40.00 | -0- |
| 01-09 | Check/Payment | 20.00 | 20.00 | 20.00 | -0- |
| 01-15 | Check/Payment | 60.00 | 60.00 | 60.00 | -0- |
| 01-20 | Check/Payment | 40.00 | 40.00 | 40.00 | -0- |

AVAILABLE CASH BALANCE DEPLETED - SUBSEQUENT
CHECK OR ELECTRONIC BILL PAYMENTS WILL BE
TREATED AS “OPEN” CREDIT BALANCE ITEMS.

| | | | | | |
|---|---|---|---|---|---|
| 01-23 | Check/Payment | 20.00 | 20.00 | -0- | 20.00 |
| 01-28 | Check/Payment | 80.00 | 80.00 | -0- | 80.00 |
| | TOTAL | 260.00 | 260.00 | 160.00 | 100.00 |

After the 01-20 check or electronic bill payment, the available cash balance that ordinarily credited the check or electronic bill payment debits to the initial available credit balance was depleted; however, check or electronic bill payments were still possible on 01-23 and 01-28 being that they comprise “open” credit balance items, which most likely will entail a levy of accrued interest and/or fees, whereby the debits to the initial available credit balance that comprise the open items will be paid back by the payer at a future time. It is very important to note that automatically enabling check or electronic bill payments in excess of any available cash balances (thereby resulting in open items on the initial credit balance, or resulting in accessing a line of credit as an overdraft safeguard, or even resulting in an overdraft, depending on the given check or electronic bill payment embodiment and/or circumstances) is an optional and additional aspect of the method. It is entirely possible for an account provider to allow or not allow such open credit balance items; furthermore, a payer could have the preset option of allowing open credit balance items, or to not allow open credit balance items in excess of available cash on hand in the payer's account. In such instances where open credit balance items are not automatically permitted, or are otherwise not desired, any check or electronic bill payment presentation that exceeds the available cash balance(s) can be rejected, and/or a notification regarding the check or electronic bill payment can inform the payer of the deficient cash balances(s) condition, and ask the payer whether an open credit balance item is desired in place of a check or electronic bill payment debit from the payer's available cash balance(s). Nonetheless, enabling, or even encouraging, open credit balance items is viewed as a useful and salient aspect pertinent to any applicable embodiment or example comprising the present disclosure.

Check or Electronic Bill Payments—“Paid Together” Embodiments

In the following example, check or electronic bill payments debit the initial available credit balance; however, instead of automatically paying the individual debits to the initial available credit balance “in-turn” with at least one available cash balance, the at least one available cash balance is cumulatively frozen, suspended, earmarked, or otherwise allocated for the amounts of the check or electronic bill payments, and the checks/payments are “paid together” at a given time, such as on a specific date, after a given time interval, such as every two weeks, or before, at, or after the close of a billing cycle, using the cumulatively frozen cash balance.

| | | | Credit Bal | Cash Bal | Net Effect |
|---|---|---|---|---|---|
| Date | Description | Amount | Debit | Frozen | Credit Bal |
| 01-02 | Check/Payment | 40.00 | 40.00 | 40.00 | 40.00 |
| 01-09 | Check/Payment | 20.00 | 20.00 | 60.00 | 60.00 |
| 01-15 | Check/Payment | 60.00 | 60.00 | 120.00 | 120.00 |
| 01-20 | Check/Payment | 40.00 | 40.00 | 160.00 | 160.00 |
| 01-23 | Check/Payment | 20.00 | 20.00 | 180.00 | 180.00 |
| 01-28 | Check/Payment | 80.00 | 80.00 | 260.00 | 260.00 |
| 01-31 | FROZEN CASH BALANCE IS DEBITED TO | | | | |
| | CREDIT CHECK OR ELECTRONIC BILL PAYMENT | | | | |
| | DEBIT AMOUNTS | | | | |
| | TOTAL | 260.00 | -0- | -0- | -0- |

On 01-31, the cumulatively frozen cash amount of $260 was transferred (debited) to credit the debits to the initial credit balance caused by the check or electronic bill payments. While either the payer and/or the account provider can perform such transfers manually, it is reasonable that automated transfers would be preferable, if not typical, in most instances.

As disclosed earlier regarding “paid in-turn” check or electronic bill payment embodiments, any “paid together” check or electronic bill payment embodiments can comprise at least one available cash balance funding source and/or at least one available credit balance funding source. As with the “paid in-turn” check or electronic bill payment embodiments, any “paid together” check or electronic bill payment embodiments can comprise any check or electronic bill payment parameters to determine which one or more than one of the at least one funding source will be used, such parameters comprising amount threshold, remainder threshold, ratio, etc.; and, account balance information. Prepayment is also a possibility, where at least one check or electronic bill payment is manually or automatically paid prior to the time when the check or electronic bill payments are paid together (where, per the above example, prepayment would occur prior to the 01-31 crediting of the check debit amounts). Such prepayments can occur using an online entry, customer service representative, etc. Furthermore, such prepayment can be subsequently readjusted (unpaid), and repaid again. In fact, this disclosure places no theoretical limits on the amount of times a given check or electronic bill payment can be prepaid, unpaid, then repaid prior to the transactions being “paid together”. Even after the transactions are paid together, it is within the scope of this disclosure to enable at least one subsequent readjustment or “unpayment” of the “paid together” transactions.

Check or Electronic Bill Payments—“Paid Together”—Depleted Available Cash Balance

This example shows a “paid together” embodiment whereby the available cash balance available for freezing becomes depleted. As a result of the depletion condition, no additional cash balance funds can be allocated to pay for the debits to the initial credit balance that result due to the check or electronic bill payments.

| | | | Credit | Cash Bal | Net Effect |
|---|---|---|---|---|---|
| Date | Description | Amount | Bal Debit | Frozen | Credit Bal |
| 01-02 | Check/Payment | 40.00 | 40.00 | 40.00 | 40.00 |
| 01-09 | Check/Payment | 20.00 | 20.00 | 60.00 | 60.00 |
| 01-15 | Check/Payment | 60.00 | 60.00 | 120.00 | 120.00 |
| 01-20 | Check/Payment | 40.00 | 40.00 | 160.00 | 160.00 |

ZERO CASH RESERVES REMAIN FOR FREEZING - SUBSEQUENT
CHECK OR ELECTRONIC BILL PAYMENTS WILL BE TREATED
AS “OPEN” CREDIT BALANCE ITEMS.

| 01-23 | Check/Payment | 20.00 | 20.00 | 160.00 | 180.00 |
|---|---|---|---|---|---|
| 01-28 | Check/Payment | 80.00 | 80.00 | 160.00 | 260.00 |
| 01-31 | FROZEN CASH BALANCE IS DEBITED TO PARTIALLY | | | | |
| | CREDIT CHECK OR ELECTRONIC BILL PAYMENT | | | | |
| | DEBIT AMOUNTS | | | | |
| | TOTAL | 260.00 | -0- | -0- | 100.00 |

After the 01-20 check or electronic bill payment, the available cash balance that sourced the frozen cash balance was depleted; however, check or electronic bill payments were still possible on 01-23 and 01-28 being that they comprise open credit balance items. As analogous with the earlier “paid in-turn” embodiment, kindly note that automatically enabling check or electronic bill payments in excess of the capability to allocate frozen cash balance amounts (thereby resulting in open items on the initial credit balance, or resulting in accessing a line of credit as an overdraft safeguard, or even resulting in an overdraft, depending on the given check or electronic bill payment embodiment and/or circumstances) is an optional aspect of the method. It is entirely possible for an offering entity to allow or not allow such open credit balance items; furthermore, a payer could have the preset option of allowing open credit balance items or to not allow open credit balance items in excess of the capability to allocate frozen cash balance amounts in the payers account. In such instances where open credit balance items are not automatically permitted, or are otherwise not desired, any check or electronic bill payment request that exceeds the capability to allocate frozen cash balance amounts can be rejected, and/or a notification regarding the check or electronic bill payment can inform the payer of the deficiency regarding the cash balance(s) condition, and ask the payer whether an open credit balance item is desired.

Check or Electronic Bill Payments—Combination “Paid in Turn” and “Paid Together” Embodiments

This check or electronic bill payment example is a combines “paid in-turn” and “paid together” aspects using two available cash balances. Using an amount threshold parameter, checks/payments up to $40 debit cash balance #1, where the checks/payments are “paid in-turn”, whereby checks/payments above $40 debit cash balance #2, where the amounts are frozen, and “paid together” at the end of the month.

| | | | Credit Bal | Amt Debited | Amt Frozen |
|---|---|---|---|---|---|
| Date | Description | Amount | Debit | Cash Bal #1 | Cash Bal #2 |
| 01-02 | Check/Payment | 40.00 | 40.00 | 40.00 | -0- |
| 01-09 | Check/Payment | 20.00 | 20.00 | 20.00 | -0- |
| 01-15 | Check/Payment | 60.00 | 60.00 | -0- | 60.00 |
| 01-20 | Check/Payment | 40.00 | 40.00 | 40.00 | -0- |
| 01-23 | Check/Payment | 20.00 | 20.00 | 20.00 | -0- |
| 01-28 | Check/Payment | 80.00 | 80.00 | -0- | 140.00 |
| 01-31 | FROZEN FUNDS FROM CASH BALANCE #2 ARE | | | | |
| | DEBITED TO CREDIT ALL CHECK OR ELECTRONIC | | | | |
| | BILL PAYMENT DEBIT AMOUNTS ABOVE $40 | | | | |
| | TOTAL | 260.00 | 260.00 | 120.00 | PAID |

Check or Electronic Bill Payments Using Two or More Initial Credit Balances

The following “paid in-turn” example shows where check or electronic bill payments can debit at least two initial credit balances. Using an amount threshold parameter, check/payment amounts up to $40 debit initial available credit balance #1, where check/payment amounts above $40 debit initial credit balance #2. There could be any reason for using at least two initial credit balances, such as where one balance is in-house where the other is out-of-house, different billing cycles, withdrawal minimum or maximums for a given available credit balance, (such as a daily maximum), etc.

| | | | Ini Credit | Ini Credit | Amt Debited |
|---|---|---|---|---|---|
| Date | Description | Amount | #1 Debit | #2 Debit | Cash Bal |
| 01-02 | Check/Payment | 40.00 | 40.00 | -0- | 40.00 |
| 01-09 | Check/Payment | 20.00 | 20.00 | -0- | 20.00 |
| 01-15 | Check/Payment | 60.00 | -0- | 60.00 | 60.00 |
| 01-20 | Check/Payment | 40.00 | 40.00 | -0- | 40.00 |
| 01-23 | Check/Payment | 20.00 | 20.00 | -0- | 20.00 |
| 01-28 | Check/Payment | 80.00 | -0- | 80.00 | 80.00 |
| | TOTAL | 260.00 | 120.00 | 140.00 | 260.00 |

In addition to the amount threshold parameter, other earlier disclosed parameters can be adapted to initial credit balance debiting as well, such as remainder threshold (“debit the first $20 of the check or electronic bill payment from initial credit balance #1 and debit any remainder amount above $20 from initial credit balance #2”); ratio (“debit 50% of the check or electronic bill payment from initial credit balance #1 and debit the remaining 50% from initial credit balance #2”); account balance information (“debit check or electronic bill payments up to $20 from initial credit balance #1 and debit check or electronic bill payments over $20 from initial credit balance #2; however, if initial credit balance #1 falls below $1000, then only debit initial credit balance #2 for all check or electronic bill payments”) and, account balance consumption (“if consumption of initial credit balance #1 exceeds $100 for the day, then debit initial credit balance #2, otherwise, debit initial credit balance #1”, or, “if consumption of initial credit balance #1 exceeds $1000 for the month, then debit initial credit balance #2, otherwise, debit initial credit balance #1”).

Check or Electronic Bill Payment—Determining Whether to Pay or Leave Unpaid as an Open Credit Balance Item

Check or electronic bill payment parameters can also enable which checks/payments are to be left unpaid as an open credit balance item that is to be repaid at a future time. In this “paid in-turn” example using amount threshold parameters, check/payment amounts up to $20 are paid using available balance #1 (Bal #1), which is an available cash balance; check/payment amounts above $20 up to $40 are paid using available balance #2 (Bal #2), which is an available credit balance, such as a home equity line of credit (HELOC), and check/payment amounts above $40 are left unpaid as an open credit balance items which the payer will repay at a future date.

| | | | Ini Credit Bal | Amt Debited | Amt Debited | Cash |
|---|---|---|---|---|---|---|
| Date | Description | Amount | Debit | Bal #1 | Bal #2 | Advance |
| 01-02 | Check/Payment | 40.00 | 40.00 | -0- | 40.00 | -0- |
| 01-09 | Check/Payment | 20.00 | 20.00 | 20.00 | -0- | -0- |
| 01-15 | Check/Payment | 60.00 | 60.00 | -0- | -0- | 60.00 |
| 01-20 | Check/Payment | 40.00 | 40.00 | -0- | 40.00 | -0- |
| 01-23 | Check/Payment | 20.00 | 20.00 | 20.00 | -0- | -0- |
| 01-28 | Check/Payment | 80.00 | 80.00 | -0- | -0- | 80.00 |
| | TOTAL | 260.00 | 260.00 | 40.00 | 120.00 | 140.00 |

While the amount threshold parameter enables higher value check/payment amounts to remain as open credit balance items, the opposite (enabling lower value check/payment amounts to remain as open credit balance items) are also possible. While the practicality of the above can possibly be called into question in terms of fees and/or interest, the above example basically illustrates the possibilities. In addition to the amount threshold parameter illustrated, any check or electronic bill payment parameters, such as: remainder threshold (“for check/payment amounts up to $20, debit the available cash balance to credit the debit to the available credit balance created by the check or electronic bill payment, and leave any remainder amount above $20 as an open credit balance item”); ratio (debit the available cash balance to credit the debit to the available credit balance for ¾ (three quarters) of the check or electronic bill payment amount, and leave the remaining ¼ (one quarter) of the check or electronic bill payment amount as an open credit balance item“; and, account balance information (”if the available cash balance falls below $100, allow the check or electronic bill payment to remain as an open item on the available credit balance“) may be used. Furthermore, and very importantly, the above example demonstrates where available cash balances (Bal #1) and available credit balances (Bal #2) are used as payment sources for checks/payments.

“Unpayment” Readjustment

Unpayment readjustments will be exemplified throughout the remainder of the disclosure. A given check or electronic bill payment that has already been paid can be partially or fully “unpaid” by debiting at least one available credit balance, and crediting at least one available cash balance (and/or crediting at least one second available credit balance) for the “unpaid” amount of the check or electronic bill payment. An unpayment readjustment can be deployed manually by a payer, with the payer using any kind of interface, such as an online account entry via the Internet, phone menu selection, assistance from a customer service representative, etc. that enables the end user to perform an unpayment readjustment. Unpayment readjustments may also occur automatically, where a paid check/payment is automatically readjusted, for any reason, such as where the resultant cash can be used to prevent overdrafts from occurring (such as preventing a non-sufficient funds condition from occurring, thereby preventing another transaction from rejecting), to facilitate a cash withdrawal from an ATM, and the like. Also, an automatic unpayment readjustment on erroneous or fraudulent activity may occur to help mitigate hardships related to fraudulent activity that will be discussed later. Regardless of whether an unpayment readjustment comprises a manual or automatic readjustment, the end result is basically at least one open credit balance item.

Such unpayments readjustments can comprise transaction specific readjustments, and amount specific readjustments. A transaction specific readjustment is where a payer highlights, or otherwise identifies, one or more specific paid check or electronic bill payment transactions that he wishes to “unpay”, where highlighting or otherwise identifying any check or electronic bill payment for readjustment can occur using any suitable method, such as where at least one given item is displayed on an online account interface and is “clicked on”, or whether a desired check or payment is identified using a telephone system that enables selection, conveying a selection to a customer service representative via telephone, via fax, etc. An amount specific readjustment is where a payer enters a desired amount for readjustment, resulting where specific paid check or electronic bill payment transactions are fully or partially unpaid using any desired selection criteria (typically established by the account provider, with an optional possibility of offering selection choices to the payer/account owner) such as FIFO (first in, first out), LIFO (last in, first out), lowest value transaction first, highest transaction value first, partial amounts of several transactions, etc. Furthermore, it is possible to readjust an amount where specific transactions are not identified or unpaid per say, but where an amount is unpaid resulting in a debit to at least one available credit balance and a credit to at least one available cash balance, so if an account used for check or electronic bill payment shows that there is, say, $500 in paid check or electronic bill payments available for readjustment, then the full or partial $500 amount can be subsequently unpaid, either with or without involving or specifically identifying specific check or electronic bill payment transactions for unpayment purposes, where said full or partial $500 amount becomes an open credit balance item, and at least one available cash balance is credited with said full or partial $500 amount. Such amount specific unpayment readjustments that have only paid amounts unpaid, and not specific transactions unpaid, would not necessarily need to comprise the unpayment of specific transactions, just the unpayment of amounts related to the paid transactions; nonetheless, as seen above, this disclosure does allows for an amount specific readjustment to comprise the full or partial unpayment of specific transactions in order to arrive at the desired unpayment amount.

An extremely crucial aspect here is that an unpayment readjustment is intended to not affect the payee whatsoever. Very simply, even though a given check or payment is “unpaid” at the level of the payer's account, the actual check or payment, as received by the payee, is unaffected. In fact, a given unpayment of a check or payment can even occur after a check draft or payment has cleared, after the payee has been paid in full, where the subsequent unpayment readjustment has absolutely no effect whatsoever on the “paid” status of the payee. Basically, a check or electronic bill payment that has been paid using a cash balance (either where at least one available cash balance was originally debited for a given check or electronic bill payment, or where at least one available credit balance was originally debited for a given check or electronic bill payment resulting in an open credit balance item, and at least one available cash balance was debited to pay said open credit balance item), and that is subsequently unpaid converts to an open credit balance item that the end user is expected to pay back at a later time, with an exception being where an erroneous or fraudulent charge or payment can be unpaid, enabling the erroneous or fraudulent open credit balance item to be attended to on behalf of the payer. In addition to the conversion to an open credit balance item, the cash resulting from the unpayment is credited to at least one available cash balance. Outside of an erroneous or fraudulent charge or payment, all of this repayment or readjustment activity occurring at the payer's account level is intended as having no effect on the payee's receipt of the check or electronic bill payment.

Also, a question may arise as to how long can an unpayment readjustment be performed after a paid check or electronic bill payment is posted. This is a question best left to an account provider in that certain account providers may only want to enable unpayment readjustments up to a given period, such as up to the end of a given billing cycle, while other account providers could allow for any paid check or electronic bill payment to be unpaid/readjusted months later, years later, etc., for any reason whatsoever. The basic answer is that this disclosure places no limitations or restrictions whatsoever on how long an unpayment readjustment can be performed after a paid check or electronic bill payment is posted, whereby such a decision is best left to a given account provider.

As with many things in the field of payments where end-user notification is prudent, any notification means such as E-mail can notify the payer that an automatic unpayment occurred, which could also act as an alert the payer as to potential error or fraud. In fact, such notification is also useful in the instance of a “manual” readjustment performed by or on behalf of the payer that acts as a confirmation.

“Paid in-Turn” Unpayment Readjustment

Keeping in mind where the debit to the initial credit balance caused by the check or electronic bill payment is “paid in-turn” by at least one available cash balance, the initial available credit balance that is paid by at least one available cash balance can be either manually or automatically “unpaid”, or readjusted, where at least one available cash balance is credited for the readjusted amount, and where the readjusted amounts are rendered as open credit balance items that are paid back at a future time. A readjustment is useful for many purposes, such as a higher need for the cash, to cover other check or electronic bill payment overdrafts, to pay account related fees, etc.

| | | | Credit Bal | Amt Debited | Net Effect |
|---|---|---|---|---|---|
| Date | Description | Amount | Debit | Frm Cash Bal | Credit Bal |
| 01-02 | Check/Payment | 40.00 | 40.00 | 40.00 | -0- |
| 01-09 | Check/Payment | 20.00 | 20.00 | 20.00 | -0- |
| 01-15 | Check/Payment | 60.00 | 60.00 | 60.00 | -0- |
| 01-20 | Check/Payment | 40.00 | 40.00 | 40.00 | -0- |
| 01-21 | 01-15 Amount | | | (60.00) | 60.00 |
| | Readjusted | | | | |
| 01-21 | 01-20 Amount | | | (40.00) | 40.00 |
| | Readjusted | | | | |
| 01-23 | Check/Payment | 20.00 | 20.00 | 20.00 | -0- |
| 01-28 | Check/Payment | 80.00 | 80.00 | 80.00 | -0- |
| | TOTAL | 260.00 | 260.00 | 160.00 | 100.00 |

On 01-21, the payer performed an unpayment readjustment by highlighting, or otherwise identifying, the 01-15 and 01-20 check or electronic bill payments, thereby unpaying (debiting) the initial available credit balance for a total of $100, and crediting the available cash balance for a total of $100. The payer will repay the “unpaid ” debits to the initial available credit balance at a future time. In embodiments comprising more than one available cash balance source, it is herein disclosed that a credit to at least one available cash balance as a result of a readjustment can be either to the cash balance originally used to pay the initial credit balance for the check/payment item, and/or to at least one additional available cash balance. While all check or electronic bill payment credit balance activity in the above example involves only the initial available credit balance, it is very important to note that an unpayment readjustment can debit the at least one available credit balance comprising the initial available credit balance(s) used to pay for the check/payment item; or, an unpayment readjustment can debit at least one other available credit balance in place of, or in addition to, any initial available credit balance(s) normally debited for check or electronic bill payments. Any “unpayment” is reasonably expected to be repaid; furthermore, an “unpayment” that is repaid may in fact be unpaid again being that this disclosure places no theoretical limits on the number of times a given check or electronic bill payment that has been paid can be subsequently unpaid (readjusted) and then repaid, unpaid again, etc. While the number of times a check or electronic bill payment can be paid/unpaid/repaid is theoretically unlimited, the account provider could decide whether or not to place limitations.

Traditional Cash Balance-Based Check or Electronic Bill Payment Modified with “Unpayment” Readjustment Capability

It is very important to note that readjustments per the above example are readily adaptable to traditional check or electronic bill payment embodiments where the check or electronic bill payment debits an initial available cash balance (as opposed to a credit balance as illustrated in typical examples contained herein). A paid check or electronic bill payment paid by debiting an initial available cash balance can be “unpaid” by debiting at least one associated available credit balance, thereby crediting or restoring said initial available cash balance originally debited by the check or electronic bill payment, and/or crediting at least one other available cash balance. Also, a given traditional check or electronic bill payment embodiment that debits a cash balance for payment can be enhanced or modified by associating at least one available credit balance for the purpose of enabling the “unpayment” function. Such said available credit balance may also serve an overdraft function typical in some cash balance account embodiments; however, it must be made clear that traditional overdraft credit lines do not serve in a readjustment unpayment capacity as disclosed herein.

The following example shows a typical check and/or electronic bill payment embodiment where checks/electronic bill payments debit an available cash balance. Additional is an associated credit balance used to facilitate unpayment readjustments.

| | | | Cash | | |
|---|---|---|---|---|---|
| | | | Bal | Readjustment | Net Effect |
| Date | Description | Amount | Debit | Amount Unpaid | Credit Bal |
| 01-02 | Check/Payment | 40.00 | 40.00 | -0- | -0- |
| 01-09 | Check/Payment | 20.00 | 20.00 | -0- | -0- |
| 01-15 | Check/Payment | 60.00 | 60.00 | -0- | -0- |
| 01-20 | Check/Payment | 40.00 | 40.00 | -0- | -0- |
| 01-21 | 01-15 Amount | | | (60.00) | 60.00 |
| | Readjusted | | | | |
| 01-21 | 01-20 Amount | | | (40.00) | 40.00 |
| | Readjusted | | | | |
| 01-23 | Check/Payment | 20.00 | 20.00 | -0- | -0- |
| 01-28 | Check/Payment | 80.00 | 80.00 | -0- | -0- |
| | TOTAL | 260.00 | 260.00 | 100.00 | 100.00 |

Throughout the activity illustrated above, all check or electronic bill payments debited an available cash balance. On 01-21, the payer performed a readjustment on the 01-15 and 01-20 check or electronic bill payments, thereby unpaying (debiting) the associated available credit balance for a total of $100, and crediting the available cash balance that was originally used to debit check/payment amounts for a total of $100. Kindly note that it is possible for the cash resulting from the readjustment to credit at least one desired available cash balance, which may or may not comprise the available cash balance that was originally used to pay the check/payment amounts. An associated available credit balance as referenced above may comprise one or more available credit balances of any kind. While such an enhancement comprising associating at least one available credit balance to enable readjustment (unpayment) functionality to a preexisting check/electronic bill payment embodiment is possible, it is also envisioned that self-contained embodiments comprising cash balance payment functionality with credit balance-related readjustment capability already built-in are possible.

“Paid Together” Unpayment Readjustment—“Unpaying” Funds from the Frozen Cash Balance

In a “paid together” check/electronic bill payment, the actual check/electronic bill payments are yet to be paid by any cumulatively frozen, suspended, earmarked, or otherwise allocated funds, so an unpayment readjustment basically comprises a withdrawal, or “unfreezing”, of the frozen funds. Such can comprise a transaction-specific unpayment readjustment, where at least one specific unpaid transaction is highlighted or otherwise identified, and the frozen/earmarked funds directly corresponding to the at least one specific unpaid transaction is withdrawn, whereby the at least one specific unpaid transaction is carried forward as an open item; or an amount-specific unpayment readjustment, where an amount is specified, and using any desired method as mentioned earlier such as FIFO, LIFO, etc. the frozen/earmarked funds directly corresponding to the at least one specific unpaid transaction is automatically identified, unfrozen, and withdrawn, whereby the at least one specific unpaid transaction is carried forward as an open item; or an amount-specific readjustment where specific corresponding transactions are not identified per say, but an amount of frozen/earmarked funds are unfrozen and deducted leaving a unallocated or uncovered amount on at least one available credit balance that needs to be repaid. Regardless of whether a transaction specific or amount specific readjustment, unfrozen and deducted funds may possibly result in a shortfall of “paid together” payment funds. It is important to realize that while unfrozen funds may be withdrawn, unfrozen funds do not have to be withdrawn per se. The unfrozen funds may reside in the cash balance that they were frozen in, and/or may reside in at least one other available cash balance. Also note that all of these amount/transaction selection methods are analogous to those described in the prior “paid in-turn” section on unpayment readjustments, but differ from those readjustment methods due to the fact that the earlier disclosed unpayment readjustment deals with transactions that have already been paid, and not the abovementioned unpaid transactions that are earmarked to be paid later).

The following example shows a “paid together” embodiment, where an amount corresponding to an transaction is “unpaid” (withdrawn).

| | | | Credit | Cash | |
|---|---|---|---|---|---|
| | | | Bal | Bal | Net Effect |
| Date | Description | Amount | Debit | Frozen | Credit Bal |
| 01-02 | Check/Payment | 40.00 | 40.00 | 40.00 | 40.00 |
| 01-09 | Check/Payment | 20.00 | 20.00 | 60.00 | 60.00 |
| 01-15 | Check/Payment | 60.00 | 60.00 | 120.00 | 120.00 |
| 01-20 | Check/Payment | 40.00 | 40.00 | 160.00 | 160.00 |
| 01-21 | FROZEN CASH | | | (60.00) | 160.00 |
| | BALANCE PER 01-15 | | | | |
| | TRANSACTION | | | | |
| | WITHDRAWN | | | | |
| 01-23 | Check/Payment | 20.00 | 20.00 | 120.00 | 180.00 |
| 01-28 | Check/Payment | 80.00 | 80.00 | 200.00 | 260.00 |
| 02-01 | FROZEN CASH BALANCE IS DEBITED TO PARTIALLY | | | | |
| | CREDIT CHECK OR ELECTRONIC BILL | | | | |
| | PAYMENT DEBIT AMOUNTS | | | | |
| | TOTAL | 260.00 | 60.00 | -0- | 60.00 |

On 01-21, the $60 amount corresponding to the 01-15 transactions is withdrawn from the frozen cash balance, resulting in a $60 shortfall in the 02-01 frozen cash balance debiting/initial credit balance crediting, whereby the $60 remains as an open item to be repaid later by the payer. Conventional wisdom dictates that a “frozen” balance remains frozen until the intended “unfreezing” and/or transfer debiting occurs; however, it is disclosed herein that, in given embodiments, account providers can optionally allow where frozen balances can be “tampered” with, either manually or automatically, for any purpose, and by any implementation (a manual unfreezing/withdrawal by the payer who has a higher need for the cash, an automatic unfreezing/withdrawal by the account provider to cover check overdrafts, an automatic unfreezing/withdrawal by the account provider to pay account related fees, etc.), which negates the traditional intended purpose of a frozen balance. A frozen cash balance can be part of at least one unfrozen available cash balance, and/or the frozen cash balance can comprise at least one available balance entirely separate from the at least one unfrozen available cash balance. Also, whether or not frozen cash balances, or frozen portions of available cash balances, are interest bearing, is an option to be determined, such as by those implementing the disclosed methods such as the account provider.

Check or Electronic Bill Payments—Transactions Automatically and Individually Paid in-Turn, then Automatically and Individually Readjusted in-Turn with Plural Transaction Automatically Paid Together at a Given Time Interval

This unique hybrid for check or electronic bill payments comprises where individual checks/payments on the initial credit balance are automatically paid, then automatically unpaid (readjusted), then the plurality of checks/payments are cumulatively and automatically paid together by the frozen available cash balance comprising the unpaid (readjusted) cash balance at a given later time interval. The readjusted credit balance can be the initial credit balance, and/or at least one different balance entirely, just as the readjusted frozen cash balance amounts can comprise the initial cash balance, and/or at least one different balance entirely. This hybrid embodiment has an unpayment readjustment function a core aspect of its operation.

| | | | Credit | Cash | Readjusted |
|---|---|---|---|---|---|
| | | | Bal | Bal Amt | Frozen |
| Date | Description | Amount | Debit | Paid/Unpaid | Cash Balance |
| 01-02 | Check/Payment | 40.00 | 40.00 | 40.00 | 40.00 |
| 01-09 | Check/Payment | 20.00 | 20.00 | 20.00 | 60.00 |
| 01-15 | Check/Payment | 60.00 | 60.00 | 60.00 | 120.00 |
| 01-20 | Check/Payment | 40.00 | 40.00 | 40.00 | 160.00 |
| 01-23 | Check/Payment | 20.00 | 20.00 | 20.00 | 180.00 |
| 01-28 | Check/Payment | 80.00 | 80.00 | 80.00 | 260.00 |
| 01-31 | FROZEN CASH BALANCE IS DEBITED TO CREDIT CHECK | | | | |
| | OR ELECTRONIC BILL PAYMENT DEBIT AMOUNTS | | | | |
| | TOTAL | 260.00 | -0- | -0- | -0- |

In this hybrid embodiment, and as explained in the prior adjacent “paid together” section regarding “unfreezing” the frozen cash balance, the frozen cash balance that is debited to credit the check or electronic bill payment credit balance debit amounts can, depending on the embodiment, be fully or partially “unfrozen” and withdrawn by either the account provider or the payer for any reasons; or, a given embodiment could prohibit such unfreezing. Unfrozen funds that are withdrawn and not somehow restored will result in open credit balance items that the payer will be expected to repay later.

End-User Security—Fraud Assistance

An especially salient advantage to the “crebit” methods of check or electronic bill payments pertains to end-user security. Normally, when a checkbook is stolen, fraudulent checks generally present difficulties to the rightful account owner. Also, once the fraudulent checks are reported, it often takes weeks for the cash to be restored to the account owner, and for non-fraudulent bounced check issues to be resolved. With the “crebit” methods, problems regarding stolen checks that result in fraudulent checks can be somewhat minimized, in that any fraudulent “paid in-turn” checks can be automatically readjusted to restore cash balances, and any fraudulent “paid together” checks can have funds automatically unfrozen or unallocated, also to restore cash balances.

With regards to electronic bill payments, even though fraudulent electronic bill payments are not indicated as being particularly problematic, erroneous electronic bill payments can and do occur, especially where a merchant, product, or service provider basically “pulls” funds from a payer's electronic bill payment account. In the following example, on 01-21, a payer checks his check/payment account, and notices two debits (one on 01-15, the other on 01-20) that have no ready recognition or explanation. After further investigation, the payer concludes that the debits were erroneous electronic bill payments “pulled” by one of the payer's service providers, and takes corrective measures by performing manual “unpayment” readjustments on the two debits, which results in the payer's cash account being credited, and where the erroneous debits convert to open items on the credit balance, and notifying the service provider of the erroneous activity. The service provider investigates, acknowledges the problem and on 1-22 “pushes” back the “pulled” payments, which credits and essentially zeros out the erroneous open credit balance items.

| | | | Credit | Amt Debited | |
|---|---|---|---|---|---|
| | | | Bal | Frm | Net Effect |
| Date | Description | Amount | Debit | Cash Bal | Credit Bal |
| 01-02 | Check/Payment | 40.00 | 40.00 | 40.00 | -0- |
| 01-09 | Check/Payment | 20.00 | 20.00 | 20.00 | -0- |
| 01-15 | Check/Payment*** | 60.00 | 60.00 | 60.00 | -0- |
| 01-20 | Check/Payment*** | 40.00 | 40.00 | 40.00 | -0- |
| 01-21 | 01-15 Erroneous Debit Manually | | | (60.00) | 60.00 |
| | Readjusted | | | | |
| 01-21 | 01-20 Erroneous Debit Manually | | | (40.00) | 40.00 |
| | Readjusted | | | | |
| 01-22 | Service Provider Removes Erroneous | | | | (100.00) |
| | Credit Item Amounts | | | | |
| 01-23 | Check/Payment | 20.00 | 20.00 | 20.00 | -0- |
| 01-28 | Check/Payment | 80.00 | 80.00 | 80.00 | -0- |
| | TOTAL | 160.00 | 160.00 | 160.00 | -0- |

*** ERRONEOUS PAYMENT ITEMS

Thanks to the manual unpayment readjustment procedure, the payer in the above example did not have to wait for any action by the erroneous service provider before the payer's cash balance was credited for the erroneous deduction, possibly sparing the payer from issues that can arise from unexpectedly reduced cash balance levels. Such is useful as a partial but very helpful remedy for a problem resolution that could potentially take days, if not weeks.

This next example will illustrate how an automatic unpayment readjustment functions within the context of fraudulent activity. For clarification purposes, all activity in this example will center around check drafts. Here, the payer has a cash account with an available balance on 01-01 of $1000.

| | | | Credit Bal | Amt Debited | Net Effect |
|---|---|---|---|---|---|
| Date | Description | Amount | Debit | Frm Cash Bal | Cash Bal |
| 01-01 | Open Cash Balance Amount | | | | 1,000.00 |
| 01-02 | Check | 40.00 | 40.00 | 40.00 | 960.00 |
| 01-09 | Check | 20.00 | 20.00 | 20.00 | 940.00 |
| 01-12 | Fraudulent Check | 1,000.00 | 1,000.00 | 1,000.00 | (60.00) |

| 01-12 | 01-02 and 01-09 Check-Auto Unpay | | (60.00) | -0- |
|---|---|---|---|---|
| 01-12 | E-mail Notice sent to Payer regarding Auto Unpay | | | |
| 01-12 | Account Provider confirms Fraud closes Account, | | | |
| | and/or provides New Account Number | | | |
| 01-12 | Account Provider unpays | (1,000.00) | (1,000.00) | 1,000.00 |
| | Fraudulent Check restoring Cash | | | |
| | Balance, Removes Credit Bal Debit | | | |

| | | | |
|---|---|---|---|
| 01-12 | Account Provider debits Cash Balance for | 60.00 | 940.00 |
| | 01-02 and 01-09 Transactions, | | |

On 01-02 and 01-09, incoming checks are paid. On 01-12, a fraudulent $1,000 check comes in that is not only large enough to deplete the available cash balance, but is large enough to trigger automatic unpayment readjustments of the 01-02 and 01-09 checks as well. That same day, the payer notices an E-mail regarding the unpayment readjustments, investigates and sees the fraudulent charge, and notifies the account provider. The account provider confirms fraud, and either closes the account, and/or provides a new account number, then subsequently unpays the fraudulent check resulting in a credit to the cash balance for $1000 and a debit to the credit balance for $1000, removes the $1000 debit to the credit balance resulting from the unpayment of the fraudulent check, and debits the cash balance for $60 for the 01-02 and 01-09 transactions. Now, had the customer not noticed or heeded the 01-12 E-mail notice regarding the automatic unpayment, it is possible that any later incoming checks could trigger a partial, or even a full, automatic readjustment of the fraudulent $1000 charge, where the E-mail notification would surely get the payer's attention due to the large amount involved. What is most remarkable about this is that said later incoming checks could have been covered with the automatic readjustment instead of bouncing; or, due to the unique qualities of the embodiment illustrated in this particular example, the incoming checks could have simply been honored due to debiting the example's available credit balance, instead of a traditional available cash balance. Also, after such fraudulent check occurrence, the payer could have “manually” performed an unpayment readjustment on the fraudulent transaction amount himself, and transfer or withdraw some, most, or all of the cash balance credited by the unpayment readjustment.

Parameters

The logic of the presented parameter can be reduced basically down to “if/then” statements, such as “if the check or electronic bill payment is more than $40, then debit available balance #2”. Such parameters can involve simple “if/then” instructions, simple “if' instructions with complex “then” instructions, complex multi-conditional “if' instructions with simple “then” instructions, or complex multi-conditional “if' instructions with complex “then” instructions. An example of the later is: “if the check or electronic bill payment exceeds $40, and results in consumption of available balance number remaining under $1000, then debit 50% of the check/payment amount from available balance #1, 25% of the check/payment amount from available balance #2, and 25% of the check/payment amount from available balance #3; however, if the check is $40 or less, and results in consumption of available balance #1 under $500, then debit 100% of the check/payment from available balance #1—if neither of these condition sets apply, then debit available balance #4 instead”.

Credit Limit

With regards to check or electronic bill payments, an important matter concerns the credit limit comprising one or more credit balances that enable certain check or electronic bill payment embodiments. Being that myriad possibilities exist with regards to establishing, setting, or revising credit limit (s) on one or more credit balances, this disclosure places no specific limitations, or restrictions, whereby the account provider or available balance provider is wide open to use any metric(s) for establishing, setting, or revising credit limit(s) that the account provider pleases, regardless of whether the credit limit(s) mirror or otherwise resemble the amount of the available unfrozen and/or frozen cash balance(s); whether credit limit(s) track, somewhat exceed, greatly exceed, etc. any available cash balance amounts; or, where credit limit(s) are totally or somewhat related, or totally or somewhat unrelated, to any available cash balance amounts or available cash balance parameters. With regards to allowing readjustment unpayments (the “unpayment” of already paid check or electronic bill payments), while it is logical to allow such unpayments only within the constraints of a predetermined credit limit, regardless of whether such a credit limit is the same or different than the credit limit for a given available credit balance, or is the same or different than the combined credit limit balance for a plurality of available credit balances comprising the check/electronic bill payment account, this disclosure places no specific limitations, or restrictions regarding the subject of credit limits as applied to allowing or disallowing specific manual or automated unpayment readjustments.

Series and/or Parallel Transaction Movement

Per the embodiments presented above, transaction movement relating to check or electronic bill payments may comprise two distinct methods:

Where the transaction movement comprises the simple movement or shifting of a given transaction/transaction amount between two like-kind balances (from a credit balance to another credit balance, or from a cash balance to another cash balance); or, Where the transaction movement comprises the actual crediting and/or debiting of a given transaction/transaction amount, which facilitates the movement of the transaction/transaction amount between either like-kind balances (from a credit balance to another credit balance), or non like-kind balances (from a credit balance to a cash balance, or vice versa).

A given embodiment may comprise either or both methods. Keeping this in mind, any of the disclosed embodiments, from the simple to the complex, may additionally comprise complex transaction movement routines that employ any number, or kind of extra balances (regardless of whether the balances are cash balances or credit balances, or in-house or out-of-house balances), in any order, whereby nearly infinite variations are possible. Furthermore, a given payment amount can be moved in series from one balance to another, and/or parallel through more than one balance simultaneously. These complex routines can easily take place without the end-user ever knowing or suspecting. For example, in a “crebit” check or electronic bill payment embodiment, a given incoming payment amount can be moved in series and/or parallel through any number, kind and order of balances before residing on the disclosed “initial available credit balance” comprising the “crebit” embodiment. Also, in a given embodiment, a debit of any cash balances, regardless of whether they are frozen or not, can be moved in series and/or parallel through any number, type and order of balances, regardless of whether any of the balances are deemed “frozen” or not, before the debit ultimately credits another balance, such as an initial available credit balance. The same applies to out-of-house credit or cash balances comprising a given embodiment, where a given payment amount moves through a complex routine of balances.

As an overview for a given embodiment, a given incoming payment amount debit or credit can move in series and/or parallel through any number, kind and order of balances before ultimately residing on the desired balance, as can an offsetting credit or debit. Readjustments can work the same way, whereby a given readjustment can have its crediting and debiting functions move in series and/or parallel through any number, kind and order of balances prior to consummation, as can any repayment pertinent to a given readjustment. As a result, a complex transaction movement routine can comprise a few, a dozen, a hundred, etc., cash and/or credit balances, in any order, before a payment amount debit or credit ultimately resides on the desired initial or ultimate balance. Similarly, a complex transaction movement routine can comprise a few, a dozen, a hundred, etc., cash and/or credit balances, in any order, in order to perform an offsetting balance credit or debit, readjustment, repayment, etc.

It will be clear that the invention can be practiced otherwise than as particularly described in the foregoing description and examples.

Numerous modifications and variations of the present invention are possible in light of the above teachings and, therefore, are within the scope of the appended claims.

1. A method, using a check or electronic bill payment account provided by an account provider for at least one payment of at least one check or electronic bill payment between a payer and payee, for providing at least one manual or automatic unpayment readjustment of said at least one payment, wherein (a) said unpayment readjustment comprises at least one transaction specific readjustment or at least one amount specific readjustment; (b) said unpayment readjustment does not affect said payee's receipt of said check or electronic bill payment; and (c) said at least one payment was paid by one selected from (i) debiting at least one available first cash balance or (ii) initially debiting at least one available first credit balance and then crediting said at least one first credit balance by debiting at least one available second cash balance;
said method comprising:
a. identifying at least one posted check or electronic bill payment transaction comprising said transaction specific readjustment, or specifying at least one amount comprising said amount specific readjustment; and
b. unpaying at least a portion of the amount of said at least one posted check or electronic bill payment transaction, or said amount comprising said amount specific readjustment, by debiting said portion of the amount of said posted check or electronic bill payment, or debiting said amount comprising said amount specific readjustment, among at least one of said at least one available first credit balance or at least one available second credit balance; and
c. crediting said portion of the amount of said posted check or electronic bill payment pertaining to said unpayment, or crediting said amount comprising said amount specific readjustment pertaining to said unpayment, among at least one of said available first or second cash balance or second credit balance or at least one available third cash or credit balance.

2. A method, using a check or electronic bill payment account provided by an account provider for payment of at least one check or electronic bill payment between a payer and payee, for providing at least one manual or automatic unpayment readjustment comprising at least one transaction specific readjustment or at least one amount specific readjustment, wherein said unpayment readjustment does not affect said payee's receipt of said check or electronic bill payment, comprising:
a. identifying at least one posted check or electronic bill payment transaction comprising said transaction specific readjustment, or specifying at least one amount comprising said amount specific readjustment, wherein available cash balance funds corresponding to said posted check or electronic bill payment transaction, or available cash balance funds corresponding to said amount comprising said amount specific readjustment, were frozen, and where said frozen funds are earmarked for the paid-together payment of said check or electronic bill payment; and
b. unfreezing at least a portion corresponding to the amount of said posted check or electronic bill payment transaction, or unfreezing said amount comprising said amount specific readjustment.

3. A method according to claim 1, wherein said at least one portion is a percentage or amount of said at least one check or electronic bill payment amount, wherein said percentage is 0.001 to 100.000 percent or any value or range therein, and wherein said amount is $0.001 to at least $100,000 US dollars or any foreign equivalent thereof.

4. A method according to claim 1, wherein said crediting or debiting is from a cash balance in a cash account or a credit balance in a credit account.

5. A method according to claim 4, wherein said cash account is a debit account or said credit account is a credit card account.

6. A method according to claim 1, wherein said at least one of said available cash and credit balances is selected from in-house or out-of-house available credit or cash balances.

7. A method according to claim 1, wherein said check or electronic payment account comprises a first available credit balance and a first available cash balance.

8. A method according to claim 1, wherein said unpayment readjustment is applied to said at least one check or electronic bill payment as a security feature that allows fraudulent check or electronic bill payments to be unpaid from said at least one cash balance with said at least one credit balance.

9. A method for providing a check or electronic bill payment account by an account provider for at least one payment of at least one check or electronic bill payment between a payer and payee, comprising:
a. debiting at least one available first credit balance for said payment of said check or electronic bill payment, where said debiting comprises the posting and paying of said payment, and said payment comprises a debit; and,
b. crediting said at least one first credit balance by debiting at least one available second balance.

10. A method according to claim 9, wherein said second balance is a cash or second credit balance.

11. A method according to claim 9, wherein said debit is individually paid in-turn at a given time interval by said second balance.

12. A method according to claim 9, wherein said debit comprises a plurality of debits that are automatically paid together at a given time interval by said second balance.

13. A method according to claim 9, wherein said check or electronic payment account comprises a first available credit balance and a first available cash balance.

14. A method according to claim 2, wherein said at least one portion is a percentage or amount of said at least one check or electronic bill payment amount, wherein said percentage is 0.001 to 100.000 percent or any value or range therein, and wherein said amount is $0.001 to at least $100,000 US dollars or any foreign equivalent thereof.

15. A method according to claim 2, wherein said crediting or debiting is from a cash balance in a cash account or a credit balance in a credit account.

16. A method according to claim 15, wherein said cash account is a debit account or said credit account is a credit card account.

17. A method according to claim 2, wherein said at least one of said available cash and credit balances is selected from in-house or out-of-house available credit or cash balances.

18. A method according to claim 2, wherein said check or electronic payment account comprises a first available credit balance and a first available cash balance.

19. A method according to claim 2, wherein said unpayment readjustment is applied to said at least one check or electronic bill payment as a security feature that allows fraudulent check or electronic bill payments to be unpaid from said at least one cash balance with said at least one credit balance.
